(19) United States
(12) Patent Application Publication
(10) Pub. No.: US 2022/0125071 A1
(43) Pub. Date: Apr. 28, 2022

(54) Methods of Isolating Plant Protein and Related Compositions

(71) Applicant: Clemson University Research Foundation, Clemson, SC (US)

(72) Inventors: Dilrukshi Thavarajah, Pendleton, SC (US); Pushparajah Thavarajah, Pendleton, SC (US)

(73) Assignee: Clemson University, Clemson, SC (US)

(21) Appl. No.: 17/512,136

(22) Filed: Oct. 27, 2021

Related U.S. Application Data
(60) Provisional application No. 63/106,015, filed on Oct. 27, 2020.

(51) Int. Cl. A23J 1/14; A23J 1/12; B01D 21/26

(52) U.S. Cl. CPC A23J 1/14; B01D 21/262; A23J 1/12

(57) ABSTRACT

Disclosed herein are various organic plant protein compositions including a balanced amino acid profile with no chemical residues. Further disclosed herein are methods for creating organic plant protein compositions from organic plant material(s). In some embodiments, the organic plant protein composition includes pea protein, sorghum protein, organic baking powder, and organic vinegar.

### CROSS-REFERENCE TO RELATED APPLICATIONS

This application claims priority and is related to U.S. Provisional Application Ser. No. 63/106,015 filed on Oct. 27, 2020 and entitled Methods of Isolating Plant Protein and Related Compositions. The entire contents of this patent application are hereby expressly incorporated herein by reference including, without limitation, the specification, claims, and abstract, as well as any figures, tables, or drawings thereof.

### GOVERNMENT LICENSE RIGHTS

This invention was made with government support under Grant No. 2018-51300-28431, awarded by the United States Department of Agriculture—National Institute of Food and Agriculture—Agriculture and Food Research Initiative—Organic Agriculture Research and Extension Initiative. The government has certain rights in the invention.

### FIELD OF THE INVENTION

The various embodiments herein relate to plant proteins for food applications, and more specifically to organic plant proteins, including methods of isolating certain organic plant proteins that result in liquid and powered protein extracts and isolates.

### BACKGROUND OF THE INVENTION

Various plant proteins are available in today's market for use in various food applications. These known plant proteins are nonorganic, high in sodium, contain allergens and are concentrated with agricultural chemical residues, including, for example, herbicides and pesticides. Further, these known plant proteins are deficient in or lack essential amino acids such as sulfur-containing amino acids. In addition, various known plant proteins have very low human digestibility.

There is a need in the art for highly digestible, organic, amino acid balanced, and nutritious plant proteins and methods for isolating such proteins.

### BRIEF SUMMARY OF THE INVENTION

Discussed herein are various methods for the isolation and extraction of plant proteins and the resulting plant protein compositions. In various embodiments, the plant proteins derived from the disclosed methods are complete proteins, have high human digestibility, are rich in essential amino acids, and are organic.

In Example 1, a composition comprises organic pea protein, organic sorghum protein, organic baking powder, and organic vinegar.

Example 2 relates to the composition according to Example 1, wherein the composition comprises the organic baking powder and organic vinegar in an amount of about 0.1 wt-% or less.

In Example 3, a method for creating organic plant protein comprises grinding raw plant material, mixing the plant material with water to create a solution, raising the solution pH, separating the solution into solid and supernatant components, lowering the supernatant pH, and separating a solid and a liquid portion from the supernatant to create solid and liquid protein products.

Example 4 relates to the composition according to Example 3, wherein the raw plant material is at least one of pea, sorghum, lentil, and chickpea materials.

In Example 5, a method for creating organic plant protein comprises mixing raw plant material with water to create a solution, adjusting the solution pH, separating the solution into solid and supernatant components, lowering the supernatant pH, precipitating the supernatant into a precipitate, and drying the precipitate to create a dry protein product.

Example 6 relates to the method according to Example 5, further comprising grinding raw plant material before mixing the raw plant material with water.

Example 7 relates to the method according to Example 5, wherein the mixing the raw plant material with water further comprises stirring the solution.

Example 8 relates to the method according to Example 5, wherein the adjusting the solution pH comprises raising the solution pH to a level ranging from about 8 and about 11.

Example 9 relates to the method according to Example 5, wherein the adjusting the solution pH comprises raising the solution pH to a level ranging from about 5 to about 9.

Example 10 relates to the method according to Example 5, wherein the adjusting the solution pH comprises raising the solution pH to a level ranging from about 6 to about 8.

Example 11 relates to the method according to Example 5, wherein the adjusting the solution pH further comprises mixing the solution.

Example 12 relates to the method according to Example 5, wherein the separating the solution comprises centrifuging the solution.

Example 13 relates to the method according to Example 5, wherein the lowering the supernatant pH comprises lowering the solution pH to a level ranging from about 3 and about 6.

Example 14 relates to the method according to Example 5, wherein the lowering the supernatant pH comprises lowering the solution pH to a level ranging from about 5 to about 9.

Example 15 relates to the method according to Example 5, wherein the lowering the supernatant pH comprises lowering the solution pH to a level ranging from about 6 to about 8.

Example 16 relates to the method according to Example 5, further comprising grinding the dry protein product.

Example 17 relates to the method according to Example 5, wherein the dry protein product contains a protein content of at least 60% of the raw plant material.

Example 18 relates to the method of according to Example 5, wherein the method does not include the addition of any added sodium and/or chloride.

Example 19 relates to the method according to Example 18, wherein the chloride within the dry protein product is in a concentration of less than about 50 mg/100 g on a dry weight basis.

Example 20 relates to the method according to Example 5, wherein the dry protein product provides a source of prebiotic carbohydrates and comprises less than about 4% of readily available sugars comprising glucose, fructose, sucrose, or a combination thereof.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

FIG. 1A shows pea protein, according to one implementation.

FIG. 1B shows sorghum protein, according to one implementation.

FIG. 2 is a flow diagram of a method of isolating proteins, according to one implementation.

FIG. 3 is a flow diagram of another method of isolating proteins, according to another implementation.

### DETAILED DESCRIPTION OF THE INVENTION

Disclosed and contemplated herein are methods for isolating organic proteins from various plant products and creating organic protein compositions resulting therefrom. In certain embodiments, high-quality plant proteins may be derived from pulse crops—lentils, peas, chickpeas—and sorghum. In further embodiments, the plant proteins may yield balanced amino acid profiles, including all essential amino acids and include highly digestible proteins. Still further, the disclosed and contemplated methods allow for plant protein compositions without chemical residues, including sodium residues.

In various implementations, the methods disclosed or contemplated herein yield protein compositions (including, for example, powders and solutions) that may be enriched with other natural minerals, vitamins, and other micronutrients, as would be appreciated. In certain implementations, the disclosed protein compositions may have better bioavailability and/or more balanced essential and non-essential amino acid profiles than other prior known plant proteins.

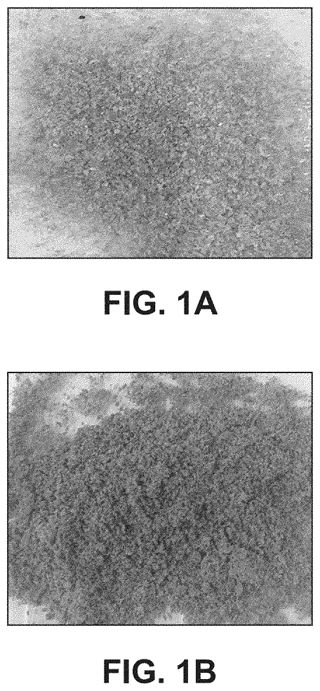

In various embodiments, the methods described herein may yield either dry or liquid protein compositions. FIGS. 1A and 1B show pea and sorghum protein compositions, respectively, from the disclosed methods. In various implementations, the pea and sorghum protein compositions may be blended to provide a composition containing all essential amino acids. While the compositions of FIGS. 1A and 1B are dry compositions, the various protein compositions can be used in solid, liquid, and semi-solid foodstuffs. The disclosed protein compositions provide storage stabilities, textural properties, and chemical-free taste profiles in comparison to known organic protein products.

Various protein composition implementations may be up to about 99% pure organic protein, and in some embodiments up to 99.9% pure organic protein, that is free of chemical residues commonly found in prior known commercially available products. That is, the protein composition does not contain added sodium, chloride, and/or other chemicals with the exception of organic baking soda and/or organic vinegar, as will be discussed further below. In various implementations, the concentration of chloride in the protein composition is less than about 75 mg/100 g, less than 60 mg/100 g, less than 50 mg/100 g, or less than 45 mg/100 g. In further implementations, the concentration of chloride in the protein composition is on a dry weight basis. As the protein composition does not contain added sodium or chloride sources, the resulting protein isolates utilizing the methods of the invention have less than one-fourth of the sodium and/or chloride levels compared to proteins available in the market. Further, the protein compositions disclosed herein may be vegetarian, major allergen-free, and gluten-free. In various implementations, the plants used in the methods are organically grown such that the starting raw materials are plant materials that are 100% organic and contain no pesticides or chemical residues.

Disclosed herein are two exemplary isolation processes for producing the organic protein compositions. Both of the specific methods discussed in detail below can be used to isolate either pea or sorghum protein, or both. Alternatively, it is understood that other known plant proteins can be isolated using the methods disclosed or contemplated herein, including other pulses and legumes, for example. Some non-limiting examples of such additional plants that can be used as the raw materials include lentil, chickpea, faba bean, mungbean, dry bean, cowpea, pigeon pea, soybean, and other protein rich plants. Further, the starting materials can come from any other plant source that has significant protein quantities, such as protein quantities that are greater than about 5%. In addition, the starting materials can also come from algae and other microbial based protein sources.

According to certain embodiments, the plant protein source is the seed. For example, the pea plant material that serves as the raw material is the seed. However, it is understood that other plant parts—such as, for example, the stalk, leaf, root or other part—can serve as the starting plant material.

In one implementation, in those embodiments in which the resulting composition has two or more protein sources (such as, for example, pea and sorghum), the two or more protein sources can be processed separately, or together. Thus, in the case of a composition containing pea and sorghum, in one embodiment, the pea and sorghum are processed separately according to any of the method implementations herein. Alternatively, the pea and sorghum can be processed together. In implementations where two or more protein sources are used, each protein source is present in an amount of from about 10 wt-% to about 90 wt-%, from about 20 wt-% to about 80 wt-%, or from about 25 wt-% to about 75 wt-%. In an aspect, the total concentration of the protein source in the composition comprises from about 10 wt-% to about 99.9 wt-%, about 20 wt-% to about 99.9 wt-%, about 30 wt-% to about 99.9 wt-%, about 40 wt-% to about 99.9 wt-%, about 50 wt-% to about 99.9 wt-%, about 60 wt-% to about 99.9 wt-%, about 70 wt-% to about 99.9 wt-%, about 80 wt-% to about 99.9 wt-%, about 90 wt-% to about 99.9 wt-%, or about 95 wt-% to about 99.9 wt-%. Without being limited according to the invention, all ranges recited are inclusive of the numbers defining the range and include each integer within the defined range.

It is understood that, with respect to both exemplary methods described below, according to certain embodiments, the raw material (plant product) should be in a powder form prior to processing. Thus, as an initial matter, if not already in powder form, the plant product is ground into a fine powder. For example, in one implementation in which the plant product is pea seeds, the seeds are ground into a fine powder using a known grinding apparatus such as a mill. Similarly, sorghum and any other plant product can be ground into a powder in a similar fashion. In certain implementations, the seeds may be ground into a fine powder of less than about 0.5 mm particle sizes. According to some embodiments, the seeds may be ground using a known UD cyclone mill to a particle size at sieve no. 35, although other equipment and processes for grinding are possible as would be appreciated by those of skill in the art. After the grinding step is complete, the resultant powders may be cooled to about room temperature prior to further processing as described below.

According to certain embodiments, both exemplary methods described below results in the reduction of protein waste in discarded solvents. Existing methods in the art fail to recover most of the protein in raw powder as the protein is a part of solvent/liquid waste streams. In contrast, the exemplary methods described below recover at least an additional 10% protein into the final product, reducing protein wastes in discarded solution streams. According to one embodiment, both exemplary methods described below recover at least 50%, at least 60%, at least 70%, or at least 80% of protein in raw powder.

The protein isolation processes according to embodiments of the two exemplary methods described below may further provide a source of carbohydrates. The processes result in a good source of prebiotic carbohydrates. A prebiotic is a food ingredient that passes the small intestines without being substantially digested, such as a non-digestible oligosaccharide, and that beneficially affects the host by selectively stimulating the growth and/or activity of one or a limited number of potentially beneficial bacteria in the colon. In various embodiments herein, prebiotic carbohydrates are substances belonging to a class of carbohydrates that cannot be broken down in the upper digestive tract and serve as a selective food source for certain microorganisms in the colon. Examples of prebiotic carbohydrates include, but are not limited to, prebiotic products that are produced from various plants (zichorie, artichoke, etc.) having a group name of “fructo-oligosaccharides”, whey-based derivatives having a group name of “galacto-oligosaccharides”, and a constantly expanding spectrum of specialty sugars. In certain aspects, the prebiotic carbohydrate comprises oligofructose, inulin, galacto-oligosaccharides, oligosaccharides from soybeans, isomalto-oligosaccharides, xylo-oligosaccharides, or combinations thereof. Further, the exemplary processes result in an isolated protein composition having less than 7%, 5%, 4%, 3%, 2%, or 1% by weight of readily available sugars comprising glucose, fructose, sucrose, or a combination thereof.

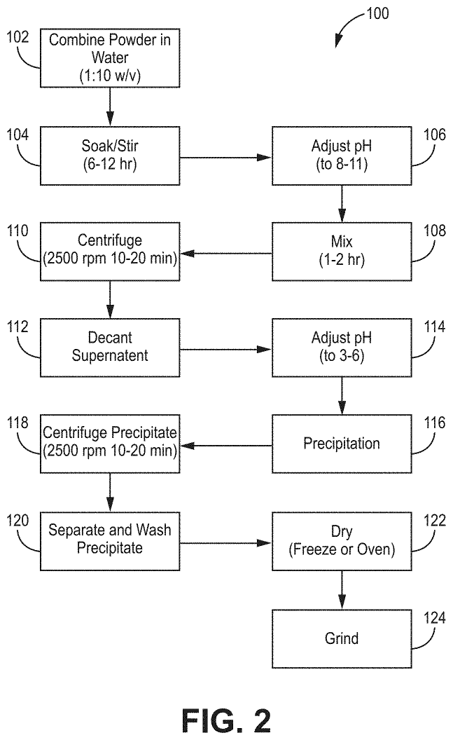

FIG. 2 shows a diagram of a first exemplary process 100 for isolating plant-based proteins, according to one embodiment. In one step as shown in the figure, the plant product powder (produced from the grinding step described above) can be combined with water (box 102) at a ratio of about 1:10 w/v such that the powder can be soaked in the water (box 104). Alternatively, the ratio can range from about 1:2 to about 1:50 w/v. In various implementations, the water is high purity grade water (<0.5Ω). Alternatively, the water can be any known form of water from any known source, including, for example, portable water, purified water, water sourced from a city or other local source, or any other type of water suitable for food and beverage applications. The water, according to certain embodiments, can be added to the various powders separately. For example, two slurries may be used: (1) a pea powder and water combination; and (2) a sorghum powder and water combination.

As part of the “soaking” step (box 104), according to certain embodiments, the resulting mixtures of plant product and water can be stirred, such as via magnetic, mechanical blade stirrers, or other known stirring mechanisms as would be appreciated by those of skill in the art. In various implementations, the slurries are stirred (box 104) for a period of timing ranging between about 1 hour and about 12 hours. Alternatively, the soaking and stirring step (box 104) lasts for between about 6 and about 12 hours.

In a further step, according on one embodiment, the pH of the mixture is raised (box 106). In certain implementations, the pH of the mixture is adjusted to between about 8 and about 11, or, alternatively, to about 9.5. According to certain implementations, the pH is raised using sodium free organic baking powder. Alternatively, other known solutions or bases may be used to raise the pH. For example, 0.1 M potassium hydroxide (KOH) may be used. Alternatively, the KOH can be used in an amount ranging from about 10⁻⁶ M to about 10⁻¹ M. In a further alternative, calcium hydroxide, calcium carbonate, or similar solutions can be used, including similar alkaline solutions. In various implementations, the solution used to raise the pH is sodium free. In various embodiments, the amount of organic baking powder or other base required to adjust the pH will be less than about 0.1 wt-% of the mixture.

In certain implementations, the pH adjustment of the mixture includes mixing (box 108) for between about 1 and about 2 hours. That is, according to some embodiments, the pH can be adjusted uniformly by mixing the mixture after the addition of the solution or base. The pH adjusted mixture may optionally then be stored for a prolonged period, such as for about 16 hours at 4° C. Alternatively, the mixture can be stored for a period ranging from about 1 hour to about 7 days at a temperature ranging from about 1° C. to about 5° C.

In the next step, the mixture is separated into solid and liquid fractions via a centrifuge (box 110) or other appreciated device/process. This first centrifuge/separation step (box 110) results in two fractions: (1) a solid fraction that contains non-protein components of the plant material, and (2) liquid fraction (or “supernatant”) containing proteins. In certain embodiments, the mixture is centrifuged at about 2500 rpm for about 10-20 minutes. Alternatively, the mixture can be centrifuged at a speed ranging from about 500 rpm to about 10,000 rpm for a time period ranging from about 5 minutes to about 10 hours. After centrifugation, the two fractions are separated. For example, in one embodiment, the liquid portion can be decanted (box 112) to separate the supernatant from the solid fraction. Alternatively, the two fractions can be separated in any known fashion.

In accordance with certain embodiments, the pH of the supernatant may then be lowered to a pH between about 3 and about 6 (box 114). In various implementations, the pH is lowered using organic vinegar, although various other acidic solutions or compositions may be used as would be appreciated. In one example, 1 M organic acetic acid (CH₃COOH) may be used. In various embodiments the amount of organic vinegar or other acidic composition required to lower the pH will be less than about 0.1 wt-% of the mixture.

In alternative implementations, the pH may be lowered to a neutral pH (about 7.0). In certain implementations, these neutral pH solutions may be blended to yield balanced essential amino acid profiles. That is, a pea-based solution and a sorghum-based solution may be blended, in one example. These neutral solutions, individually or blended, may be used in beverage or liquid food stuff applications, for example.

After lowering the pH of the supernatant, the protein is precipitated (box 116). According to certain implementations, the solution may be left for a period ranging from about 1 hour to about 7 days for protein precipitation. Alternatively, the time period can range from about 1 hour to about 12 hours.

Continuing with the embodiment of FIG. 2, the precipitate of the protein solution can be centrifuged (box 118) in certain embodiments. In various implementations, the precipitate may be centrifuged (box 118) at about 2500 rpm for about 10 minutes. Alternatively, the precipitate can be centrifuged at a speed ranging from about 500 rpm to about 10,000 rpm for a time period ranging from about 5 minutes to about 10 hours.

In a further step, the precipitate of the second centrifugation can then be separated and washed (box 120). The separation can occur via any known separation technique. In various implementations, the separated precipitate may be washed (box 120) with water to dissolve salts or other water-soluble components.

In various implementations in which a dry product is desired, water in the composition may be removed via various drying processes (box 122). For example, drying may be done via freeze drying, mild temperature oven drying, spray drying, or any other known mild drying method. In certain embodiments, the drying temperature can range from about 45° C. to about 100° C. Alternatively, in those embodiments in which a liquid product is desired, there is no drying step at this point.

In certain implementations in which the final product is a dry product, the dried protein may be ground (box 124) into a powder and/or packaged as a final product.

In various implementations, the dried and ground products resulting from the exemplary process described above may be blended to create a composition having balanced amino acid profile. In one example, pea and sorghum protein powders may be mixed because pea naturally lacks methionine and cysteine while sorghum lacks lysine. As such, when combined, the resulting composition of pea and sorghum proteins is a balanced whole protein blend. The final compositions may be used in food stuff applications, such as solid food stuffs, liquid food stuffs (such as milk. for example), and semi-solid food stuffs (such as yogurt, for example).

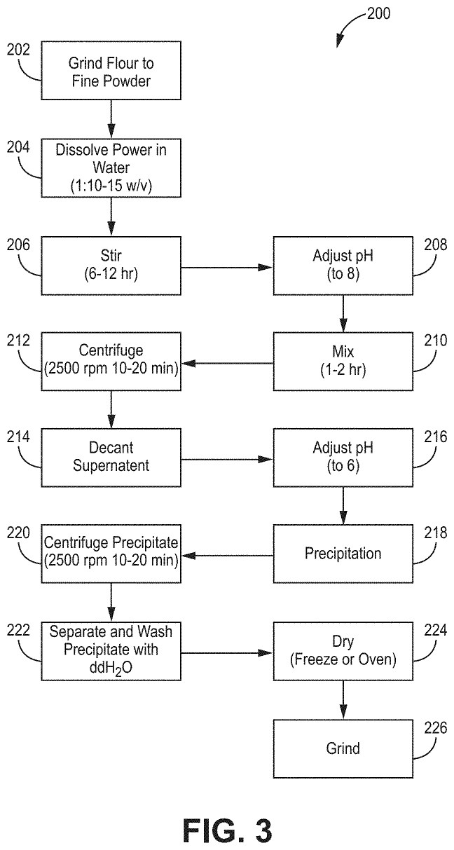

FIG. 3 shows an alternative process 200 for isolating plant proteins, according to another embodiment. According to certain embodiments, the second isolation process 200 set forth in FIG. 3 is capable of isolating the target protein(s) without denaturing or breaking down those proteins. Denaturing proteins reduces the digestibility and subsequent use of those proteins, such as, but not limited to, use in beverage and semi solid food applications. The second isolation process can isolate proteins that are not denatured and thus are more digestible and have more uses than denatured proteins. The second process isolates proteins that are not denatured by maintaining a pH range of the mixture that is neutral or substantially neutral during the process. More specifically, the mixtures in this second process are maintained within a pH range of about 5 to about 9, according to some implementations. Alternatively, the mixtures are maintained within a pH range of about 6 to about 8.

Continuing with FIG. 3, in a first step of the process 200, as discussed above as a precursor to the first process embodiment, pea and sorghum plant products are ground, separately, into fine powders (box 202). Of course, as is true with the first exemplary isolation method, alternative plant protein sources may be used, as would be appreciated and as described herein. For example, the seeds and/or flours from pea, sorghum, or other pulse plants can be the raw materials used in these isolation processes. In certain implementations, the seeds and/or flours may be ground into a fine powder of less than about 0.5 mm particle size. According to some embodiments, the grinding (box 202) may be done using a known UD cyclone mill to a particle size at sieve no. 35, although other equipment and processes for grinding are possible as would be appreciated by those of skill in the art. After the grinding step (box 202) is complete, the resultant powders may be cooled to about room temperature prior to further processing.

In a further step, the powder may be dissolved in water at a ratio of about 1:10 w/v to create a slurry (box 204). Alternatively, the ratio can range from about 1:2 w/v to about 1:50 w/v. According to certain embodiments, this soaking step (box 204) can be identical or substantially similar to the soaking step (box 104) as described above and depicted in FIG. 2 with respect to the first process.

In a stirring step (box 206), according to one embodiment, the slurries are stirred for a period of timing ranging between about 6 hours and about 12 hours. It is understood that the soaking and stirring steps can be performed separately, or at the same time.

Next, the pH of the slurry can be raised (box 208), according to one embodiment. In certain implementations, the pH of the mixture is adjusted to about 8. According to certain implementations, the pH is raised using 1 M potassium hydroxide (KOH). After the pH is adjusted, the mixture may then be mixed (box 210) for between about 1 and about 2 hours to achieve a homogenous solution.

In the next step, the slurry is centrifuged (box 212). In certain embodiments, the slurry is centrifuged at about 2500 rpm for about 10-20 minutes. This first centrifuge/separation step (box 110) results in a solid fraction that contains non-protein components of the plant material and supernatant or liquid portion containing proteins. After centrifugation the liquid portion (also referred to as a “supernatant”) may be decanted (box 214) or otherwise separated from the solid non-protein components.

In a further step, the pH of the supernatant may then be lowered to a pH of about 6 (box 216). In various implementations, the pH is lowered using 1 M organic acetic acid (CH₃COOH) may be used. After lowering the pH of the supernatant (box 216), the solution may be left for a period ranging from about 1 hour to about 7 days for protein precipitation (box 218). Alternatively, the period can range from about 1 hour to about 12 hours.

The precipitate may be centrifuged (box 220). In various implementations, the precipitate may be centrifuged (box 118) at about 2500 rpm for about 10 minutes. In a further step, the precipitate is then be separated and washed (box 222). In various implementations, the precipitate may be washed (box 120) with water to dissolve salts or other water-soluble components. In various implementations, the water is double distilled water (ddH₂O).

In various implementations, water in the composition may be removed via various drying processes (box 224). For example, drying may be done via freeze drying, mild temperature oven drying, spray drying, or any other known mild drying method. In certain embodiments, the drying temperature can range from about 45° C. to about 100° C.

In certain implementations, the dried protein may then be ground (box 226) into a powder and/or packaged as a final product.

In certain implementations, any of the various steps as described herein for this second process can be identical or substantially similar to the corresponding step as described above and depicted in FIG. 2 with respect to the first process.

As noted above, the dried and ground products may be blended to create a composition having a balanced amino acid profile. The final powder compositions may be used in food stuff applications, such as solid and liquid food stuffs.

### EXAMPLES

### Example 1

First Protein Isolation Process (“Process 1”)

Extraction was carried out by initial soaking of 20±1 g of pea powder in water at a 1:10 (W/V) ratio for 6-12 hours while using a magnetic stirrer to obtain a uniform dispersion. Then, the pea flour and water slurry pH was adjusted to 8 to 11 with 0.1 M potassium hydroxide (KOH) and mixed for 1-2 hours. The resulting solution was centrifuged at 2500 rpm for 10-20 min. The centrifuged precipitate contains non-protein components. The supernatant was decanted into a new beaker to adjust the pH to 3-6 using 1 M organic acetic acid (CH₃COOH) and left for protein precipitation. The precipitate was centrifuged at 2500 rpm for 10 min to precipitate in the supernatant. The precipitate was separated and washed with water to dissolve salts or other water-soluble components. The final product's water was removed by freeze or mild temperature (45° C.) oven drying. The dried protein was grounded to a fine powder as the final product. This process is reflected in FIG. 2 showing the diagram of a first exemplary process 100.

### Example 2

### Protein Yields of Process of Example 1

Compositions of isolated proteins produced using Process 1 described above were examined to identify the protein yields of each. More specifically, the compositions were examined using the known procedures of nitrogen analysis, high performance liquid chromatography (HPLC) and UV-Vis Spectroscopy.

The protein content of the raw materials or feed materials (i.e., the thirteen organic flour sources shown in Table 1) varied from 5 to 30% depending on the raw flour. The protein content in each isolated protein post processing using Process 1 is shown in Table 1. The remaining content is carbohydrates and about 15% water.

The protein content as shown in Table 1 is at least 10-50% higher than similar “organic” claimed protein products in the market. Solely for purposes of comparison, several commercially-available products were analyzed and found to have an estimated protein concentration ranging from about 45% to about 72%. These protein concentration values were calculated by first measuring the nitrogen value in the commercially-available products, and then converting that value to a protein percentage. Therefore, the calculated protein concentration is only an estimate, and based on the total concentration of nitrogen found in the product. The market products tested were not 100% plant proteins, and therefore, contain additional proteins, including animal protein (i.e. whey), nitrogen compounds, and other protein sources that likely inflated those protein concentrations listed above. As a result of this inflation, the actual plant protein content of the commercially-available products is understood by a skilled artisan as being less than the calculated concentrations. Currently, the food industry adds additional non-plant protein and nitrogen sources in order to elevate protein levels within their products. As such, there remains a need for products and methods that can result in high percentages of plant protein without supplementation, such as those achieved by the results shown in Table 1. Further, additional compositions produced via the same process of Example 1 resulted in isolated proteins having a protein content of up to and include about 80%.

TABLE 1
Percentages of protein using thirteen different organic flour sources

| Protein Source | Process 1 (%) |
|---|---|
| Pea 1 | 75 |
| Pea 2 | 79 |
| Pea 3 | 77 |
| Pea 4 | 76 |
| Pea 5 | 77 |
| Pea 6 | 75 |
| Pea 7 | 79 |
| Pea 8 | 80 |
| Pea 9 | 79 |
| Pea 10 | 72 |
| Sorghum 1 | 62 |
| Sorghum 2 | 62 |
| Sorghum 3 | 62 |

### Example 3

### Second Protein Isolation Process (“Process 2”)

Pea flour ground to a fine powder, as described in Example 1, was used for the second protein isolation process. The pea flour sources used in Example 2 and shown in Table 1 were the same pea flour sources utilized in this example and shown in Table 2. Here, 20 g of each flour was dissolved in water at 1:10-15 (w/v) ratios. The resulting slurry was stirred for 6-12 hours. Those two slurries pH was then adjusted to 8.0 using 0.1 M potassium hydroxide (KOH). To have a well homogenous solution at this pH, the mixture was kept for 1-2 hours. The resulting solution was centrifuged at 2500 rpm for 10-20 min. The centrifuged precipitate contains non-protein components. The supernatant was decanted into a new beaker to adjust the pH to 6.0 using 1 M organic acetic acid (CH₃COOH) and left for protein precipitation. The precipitate was centrifuged at 2500 rpm for 10 min to precipitate in the supernatant. The precipitate was separated and washed with ddH₂O (double distilled water) to dissolve any excess salts or other water-soluble components. The water on the washed proteins could be removed by freeze or mild temperature (45° C.) oven drying. The dried protein was grounded to a fine powder as the final product. This process is reflected in FIG. 3 showing the diagram of a second exemplary process 200.

The protein content as shown in Table 2 is at least 30-60% higher than similar “organic” claimed protein products in the market as discussed in Example 2. Further, additional compositions produced via the same process resulted in isolated proteins having a protein content of up to and include about 88%.

TABLE 2
Percentages of protein using ten different organic pea flour sources

| Protein Source | Process 2 (%) |
|---|---|
| Pea 1 | 86 |
| Pea 2 | 86 |
| Pea 3 | 82 |
| Pea 4 | 83 |
| Pea 5 | 82 |
| Pea 6 | 81 |
| Pea 7 | 86 |
| Pea 8 | 88 |
| Pea 9 | 87 |
| Pea 10 | 85 |

### Example 4

### Compositional Analysis

Additional analysis was completed to determine the total amino acid concentration for each pea protein source analyzed in Table 1. The results provided within Table 3 demonstrate that amino acid analysis by high performance liquid chromatography (HPLC) after digesting isolated pea proteins supports higher protein concentrations.

TABLE 3
Amino acid analysis by HPLC

| Pea | | | | | | | | | |
|---|---|---|---|---|---|---|---|---|---|
| Protein | Amino Acid (g/100 g) | | | | | | | | |
| | Cys2 | Asp | Glu | Ser | His | Gly | Thr | Met | Arg |
| 1 | 0.3 | 7.7 | 10.5 | 2.8 | 1.0 | 2.1 | 1.9 | 0.3 | 5.4 |
| 2 | 0.2 | 10.0 | 13.4 | 3.6 | 1.2 | 2.8 | 2.3 | 0.4 | 6.9 |
| 3 | 0.4 | 9.0 | 11.8 | 3.3 | 1.2 | 2.3 | 2.1 | 0.4 | 6.0 |
| 4 | 0.2 | 9.2 | 11.7 | 3.3 | 1.0 | 2.5 | 2.1 | 0.3 | 5.9 |
| 5 | 0.4 | 9.3 | 12.5 | 3.5 | 1.3 | 2.6 | 2.2 | 0.4 | 6.6 |
| 6 | 0.2 | 9.4 | 12.3 | 3.5 | 1.2 | 2.7 | 2.2 | 0.4 | 6.2 |
| 7 | 0.2 | 10.0 | 13.2 | 3.7 | 1.3 | 2.7 | 2.3 | 0.3 | 6.8 |
| 8 | 0.2 | 9.7 | 13.1 | 3.5 | 1.2 | 2.8 | 2.3 | 0.4 | 6.8 |
| 9 | 0.1 | 4.9 | 6.1 | 1.7 | 0.5 | 1.3 | 1.1 | 0.1 | 3.2 |
| 10 | 0.3 | 9.8 | 12.7 | 3.5 | 0.8 | 2.5 | 2.1 | 0.3 | 5.8 |
| | Ala | Val | Phe | Iso | Leu | Lys | Hpro | Pro | Total |
| 1 | 2.2 | 2.8 | 2.9 | 2.6 | 5.1 | 2.7 | 7.1 | 4.9 | 62.3 |
| 2 | 2.7 | 3.3 | 3.6 | 3.2 | 6.2 | 2.6 | 7.6 | 4.6 | 74.7 |
| 3 | 2.5 | 3.1 | 3.4 | 3.0 | 5.9 | 2.7 | 7.9 | 5.6 | 70.4 |
| 4 | 2.5 | 3.0 | 3.3 | 2.9 | 5.7 | 2.5 | 7.5 | 4.0 | 67.7 |
| 5 | 2.7 | 3.1 | 3.4 | 3.0 | 5.9 | 2.6 | 9.0 | 6.0 | 74.4 |
| 6 | 2.6 | 3.1 | 3.4 | 2.9 | 5.9 | 2.8 | 6.9 | 4.0 | 69.6 |
| 7 | 2.6 | 3.2 | 3.7 | 3.2 | 6.3 | 2.7 | 9.2 | 4.6 | 76.0 |
| 8 | 2.7 | 3.2 | 3.4 | 3.0 | 5.9 | 2.6 | 7.8 | 4.5 | 73.1 |
| 9 | 1.3 | 1.6 | 1.7 | 1.5 | 2.9 | 1.7 | 3.8 | 1.6 | 69.9 |
| 10 | 2.5 | 3.1 | 3.4 | 3.0 | 5.8 | 4.1 | 9.0 | 5.0 | 73.6 |

Additional analysis was completed to measure the concentration of prebiotic and readily available sugars for the pea protein sources analyzed in Table 1 (utilizing Process 1) and Table 2 (utilizing Process 2). The results are shown in Table 4.

TABLE 4
Prebiotic and Readily Available Sugars

| Pea | | | | | | | | | | | | |
|---|---|---|---|---|---|---|---|---|---|---|---|---|
| Protein | mg/100 g | | | | | | | | | | | |
| | Process 1 | | | | | | | | | | | |
| | | | | | | | | | | Stachyose + | Verbascose + | |
| | Myo- | | | | | | | | | Raffinose | Kestose | |
| | Inositol | Xylitol | Galactinol | Sorbitol | Mannitol | Arabinose | Glucose | Fructose | Sucrose | (Sta + Raf) | (Ver + Kes) | Maltose |
| 1 | 62.5 | 12.5 | 7.8 | 5.8 | 2.7 | 2.0 | 57.5 | 76.8 | 415.2 | 471.2 | 441.5 | 138.7 |
| 2 | 53.1 | 8.7 | 10.2 | 4.7 | 2.9 | 1.7 | 61.6 | 34.0 | 494.5 | 480.4 | 434.0 | 73.9 |
| 3 | 64.0 | 9.5 | 8.6 | 9.4 | 3.9 | 1.6 | 50.6 | 58.8 | 519.9 | 415.4 | 577.9 | 168.4 |
| 4 | 70.1 | 11.3 | 8.6 | 6.5 | 2.8 | 1.7 | 74.4 | 79.4 | 504.3 | 375.1 | 425.1 | 117.4 |
| 5 | 67.0 | 8.9 | 15.0 | 4.9 | 3.2 | 1.4 | 90.5 | 43.9 | 547.3 | 407.6 | 442.8 | 88.4 |
| 6 | 81.7 | 10.8 | 13.9 | 13.1 | 6.4 | 1.4 | 123.9 | 45.3 | 534.3 | 389.7 | 536.5 | 59.2 |
| 7 | 50.1 | 6.8 | 13.5 | 5.1 | 2.1 | 1.4 | 66.0 | 38.0 | 440.1 | 360.7 | 366.5 | 72.7 |
| 8 | 30.8 | 6.8 | 10.6 | 5.7 | 3.2 | 1.1 | 72.0 | 33.8 | 416.6 | 347.7 | 348.9 | 48.3 |
| 9 | 39.6 | 8.7 | 6.0 | 5.0 | 2.1 | 1.1 | 35.9 | 25.9 | 177.9 | 316.8 | 304.4 | 39.4 |
| 10 | 60.8 | 8.5 | 10.9 | 6.7 | 2.4 | 1.2 | 106.1 | 67.1 | 448.2 | 337.7 | 325.7 | 120.5 |
| | Process 2 | | | | | | | | | | | |
| | Myo- | | | | | | | | | | | |
| | Inositol | Xylitol | Galactinol | Sorbitol | Mannitol | Arabinose | Glucose | Fructose | Sucrose | Sta + Raf | Ver + Kes | Maltose |
| 1 | 53.1 | 10.6 | 6.6 | 5.0 | 2.3 | 1.7 | 48.9 | 65.3 | 352.9 | 400.5 | 375.3 | 117.9 |
| 2 | 45.2 | 7.4 | 8.7 | 4.0 | 2.5 | 1.4 | 52.4 | 28.9 | 420.4 | 408.4 | 368.9 | 62.8 |
| 3 | 54.4 | 8.1 | 7.3 | 8.0 | 3.3 | 1.3 | 43.0 | 49.9 | 441.9 | 353.1 | 491.2 | 143.1 |
| 4 | 59.6 | 9.6 | 7.3 | 5.5 | 2.3 | 1.5 | 63.2 | 67.5 | 428.7 | 318.8 | 361.3 | 99.8 |
| 5 | 56.9 | 7.6 | 12.7 | 4.1 | 2.8 | 1.2 | 76.9 | 37.3 | 465.2 | 346.5 | 376.4 | 75.2 |
| 6 | 69.5 | 9.2 | 11.8 | 11.1 | 5.4 | 1.2 | 105.3 | 38.5 | 454.2 | 331.2 | 456.0 | 50.3 |
| 7 | 42.6 | 5.8 | 11.5 | 4.3 | 1.8 | 1.2 | 56.1 | 32.3 | 374.1 | 306.6 | 311.6 | 61.8 |
| 8 | 26.2 | 5.8 | 9.0 | 4.9 | 2.7 | 0.9 | 61.2 | 28.7 | 354.1 | 295.6 | 296.6 | 41.0 |
| 9 | 33.7 | 7.4 | 5.1 | 4.2 | 1.8 | 0.9 | 30.5 | 22.0 | 151.3 | 269.3 | 258.8 | 33.5 |
| 10 | 51.7 | 7.2 | 9.2 | 5.7 | 2.0 | 1.0 | 90.2 | 57.0 | 381.0 | 287.1 | 276.8 | 102.4 |

### Protein Digestibility

Isolated protein digestibility was measured using protein digestibility assay (K-PDCAAS). Ten protein isolates obtained from five different pea flour starting material by two different processes (Process 1 & 2) protein digestibility data are shown in Table 5 and Table 6. The pea flour protein sources “Pea 1” through “Pea 5” shown in Table 5 and Table 6 are the same protein sources “Pea 1” through “Pea 5” used in Table 1 and Table 2.

TABLE 5
Percentages of protein digestibility of five
different organic pea isolates (Process 1)

| Protein Source | Digestibility (%)- Process 1 |
|---|---|
| Pea 1 | 94 |
| Pea 2 | 94 |
| Pea 3 | 92 |
| Pea 4 | 95 |
| Pea 5 | 96 |

TABLE 6
Percentages of protein digestibility of five
different organic pea isolates (Process 2)

| Protein Source | Digestibility (%)- Process 2 |
|---|---|
| Pea 1 | 95 |
| Pea 2 | 97 |
| Pea 3 | 97 |
| Pea 4 | 95 |
| Pea 5 | 99 |

As demonstrated by the results shown in Tables 1, 2, 5 and 6, Process 1 and Process 2 both resulted in higher protein content than similar “organic” claimed protein products in the market. Furthermore, as demonstrated in Tables 2 and 6, the isolation of protein compositions utilizing Process 2 resulted in even higher protein content with increased digestibility. Without being limited to any particular theory or mechanism, these results indicate that Process 2, in maintaining a pH range within about 5 to about 9, or within a pH range of about 6 to about 8, resulted in higher protein content and increased digestibility by isolating target protein(s) without denaturing or breaking down the proteins. The process preserves the native protein structure of the raw material during isolation, thereby providing a wide range of food-based applications. Not only do both Process 1 and Process 2 allow for applications to solid food but may also be applied to liquid and semi-solid foods.

### Example 5

### Blended Protein Composition

In this Example, isolated protein compositions of pea and sorghum were produced using the process of Example 1 and examined as described below.

Pea and Sorghum Blending:

The isolated pea and sorghum flours were finely ground to a powder. These powders were mixed in a 25:75, 50:50, and 75:25 (w/w) ratio, as shown in Table 7 below, and physically mixed by using a metal rod for 15-30 minutes until a visually appearing homogenous mixture.

Amino Acid Analysis:

The isolated and all blended protein amino acid compositions were determined by human digestive system protein digestion enzymes and chemicals followed by high-performance liquid chromatography with diode array and fluorescent detection. A total of 20 amino acids, including all essential amino acids, were analyzed, and final results are shown as mg/100 g of the protein composition, shown in Table 7.

Protein Quality:

The resulting blend of amino acid profiles shown in Table 7 were analyzed using HPLC. The blended composition improved concentrations of essential amino acids leucine, isoleucine, lysine, methionine, phenylalanine, threonine, tryptophan, and valine. Table 7 shows amino acid content, including six essential amino acids.

TABLE 7
Amino acid concentration of pea and sorghum blended proteins

| | Amino acid (mg/100 g) | | | | | | | | | | | | | | | | |
|---|---|---|---|---|---|---|---|---|---|---|---|---|---|---|---|---|---|
| | | | | | | | | | | Ala + | | | | | | | |
| Protein | Asp | Glu | Asn | Ser | Gln | His | Gly | Thr | Arg | Tau | Tyr | Val | Met | Iso | Leu | Lys | Pro |
| Sorghum:Pea | 885 | 2453 | 442 | 684 | 777 | 518 | 179 | 483 | 2897 | 567 | 1150 | 632 | 376 | 1269 | 1947 | 3659 | 277 |
| (25:75) | | | | | | | | | | | | | | | | | |
| Sorghum:Pea | 887 | 2200 | 397 | 567 | 701 | 461 | 138 | 425 | 2562 | 542 | 1124 | 603 | 405 | 1113 | 1739 | 3056 | 453 |
| (50:50) | | | | | | | | | | | | | | | | | |
| Sorghum:Pea | 577 | 1139 | 220 | 348 | 481 | 325 | 105 | 286 | 1887 | 440 | 799 | 401 | 334 | 631 | 1248 | 2019 | 276 |
| (75:25) | | | | | | | | | | | | | | | | | |

### Example 6

### Examination of Protein Digestibility

The in vitro digestibility of isolated protein was determined as the amount of solubilized proteins. These values were compared to egg albumin standards. Isolated pea and sorghum proteins (50±1 mg) were suspended separately in 15 mL tubes with (0.1 M) hydrochloric acid (HCl) solution and incubated for 30 min at 37° C. Initial protein solubility was measured by the Eppendorf Bio photometer at the wavelength of 280 nm. Samples were digested by treating 2 mg (5000 U/ml) of pepsin over three hours at 37° C., and then further digestion was terminated by incubating the tube in an ice/water bath. The digested protein solution was then centrifuged at 6000 rpm for 5 minutes for the sedimentation of larger constituents. Supernatant absorbance was taken at 280 nm and Ninhydrin reaction method for free amino acids resulting in the pepsin digestion.

Both Processes 1 and 2 provided digestible protein products with Process 2, giving 100% digestibility. The protein isolation method of Process 2 likely retains protein structure and provides greater enzyme access to digest those proteins. Therefore, a protein isolated from Process 2 could provide significant human health benefits. Table 8 shows the results of in vitro protein digestibility data for Process 2 proteins compared to market protein and egg albumins. Egg albumin was used as a gold standard. Market pea protein was used for comparative purposes. The “control” values represent the absorbance reading of the samples prior to any enzymatic digestion, i.e. a blank absorbance reading.

TABLE 8
In vitro protein digestibility of pea, sorghum, and blended pea-sorghum samples.

| | | Amount of solubilized proteins after enzymatic treatment (280 nm absorbance) | | |
|---|---|---|---|---|
| Protein type | Control | Rep-1 | Rep-2 | Rep-3 |
| Pea | 0.097 | 0.919 | 0.927 | 0.949 |
| Sorghum | 0.086 | 1.039 | 1.013 | 0.994 |
| Pea + Sorghum | 0.166 | 1.299 | 1.285 | 1.371 |
| Market pea | 0.051 | 0.302 | 0.264 | 0.316 |
| Egg albumin | 0.694 | 1.442 | 1.431 | 1.501 |

### Example 7

### Comparison of Isolated Proteins from Process of Example 1 to Commercially Available Proteins

TABLE 9
Pea and sorghum protein quality compared
to store-bought protein control

| Nutrient | Pea | Sorghum | Control |
|---|---|---|---|
| Protein (g/100 g) | 74 | 65 | 55 |
| Protein digestibility** | 64 | 70 | 20 |
| Moisture (g/100 g) | 6 | 7 | 12 |
| Resistant starch (g/100 g) | 0.07 | 0.38 | — |
| Total Starch (g/100 g) | 24 | 30 | — |

Prebiotic and Readily Available Carbohydrates (mg/100 g)

| | | | |
|---|---|---|---|
| Sorbitol | 6 | 39 | 0 |
| Mannitol | 0.2 | 3.8 | 3.1 |
| Glucose | 128 | 883 | 80 |
| Fructose | 29 | 827 | 47 |
| Sucrose | 1802 | 1424 | 1470 |
| Stachyose + Raffinose | 1133 | 46 | 15 |
| Verbascose + Kestose | 833 | 195 | 62 |
| Nystose | 1.3 | 0.0 | 0.1 |

Minerals (mg/100 g)

| | | | |
|---|---|---|---|
| Calcium (Ca) | 19 | 71 | 496 |
| Copper (Cu) | 3.2 | 10.2 | 1.3 |
| Iron (Fe) | 18 | 51 | 36 |
| Magnesium (Mg) | 52 | 208 | 86 |
| Manganese (Mn) | 418 | 1007 | 535 |
| Selenium (Se) | 0.8 | 0.37 | 0.4 |
| Zinc (Zn) | 3.7 | 3.5 | 6.8 |
| Sodium (Na) | ND | ND | 722 |
| Chloride (Cl) | 43.2 | NA | 260.2 |

**% Normalized to egg protein,
ND—not detected,
NA—not available

As demonstrated by the results shown in Table 9, the protein content and protein digestibility are substantially higher utilizing Process 1 as shown in Example 1 in comparison to a store-bought protein control. Furthermore, as no sodium or chloride sources are added to the protein extraction process, the resulting protein isolates utilizing the methods of the invention have less than one fourth of the chloride levels compared to proteins available in the market. The ability to achieve low concentrations of chloride levels is significant as market levels of chloride have been measured to be 200 mg/100 g or greater. Further, the isolated proteins provide a low concentration of readily available carbohydrates, including glucose, fructose, and sucrose, with no added sugars.

Although the various embodiments have been described with reference to preferred implementations, persons skilled in the art will recognize that changes may be made in form and detail without departing from the spirit and scope thereof

What is claimed is:

1. A composition comprising:
(a) organic pea protein;
(b) organic sorghum protein;
(c) organic baking powder; and
(d) organic vinegar.

2. The composition of claim 1, wherein the composition comprises the organic baking powder and organic vinegar in an amount of about 0.1 wt-% or less.

3. A method for creating organic plant protein comprising:
grinding raw plant material;
mixing the raw plant material with water to create a solution;
raising the solution pH;
separating the solution into solid and supernatant components;
lowering the supernatant pH;
separating a solid and a liquid portion from the supernatant to create solid and liquid protein products.

4. The method of claim 3, wherein the raw plant material is at least one of pea, sorghum, lentil, and chickpea materials.

5. A method for creating organic plant protein comprising:
mixing raw plant material with water to create a solution;
adjusting the solution pH;
separating the solution into solid and supernatant components;
lowering the supernatant pH;
precipitating the supernatant into a precipitate; and
drying the precipitate to create a dry protein product.

6. The method of claim 5, further comprising grinding raw plant material before mixing the raw plant material with water.

7. The method of claim 5, wherein the mixing the raw plant material with water further comprises stirring the solution.

8. The method of claim 5, wherein the adjusting the solution pH comprises raising the solution pH to a level ranging from about 8 and about 11.

9. The method of claim 5, wherein the adjusting the solution pH comprises raising the solution pH to a level ranging from about 5 to about 9.

10. The method of claim 5, wherein the adjusting the solution pH comprises raising the solution pH to a level ranging from about 6 to about 8.

11. The method of claim 5, wherein the adjusting the solution pH further comprises mixing the solution.

12. The method of claim 5, wherein the separating the solution comprises centrifuging the solution.

13. The method of claim 5, wherein the lowering the supernatant pH comprises lowering the solution pH to a level ranging from about 3 and about 6.

14. The method of claim 5, wherein the lowering the supernatant pH comprises lowering the solution pH to a level ranging from about 5 to about 9.

15. The method of claim 5, wherein the lowering the supernatant pH comprises lowering the solution pH to a level ranging from about 6 to about 8.

16. The method of claim 5, further comprising grinding the dry protein product.

17. The method of claim 5, wherein the dry protein product contains a protein content of at least 60% of the raw plant material.

18. The method of claim 5, wherein the method does not include the addition of any added sodium and/or chloride.

19. The method of claim 18, wherein the chloride within the dry protein product is in a concentration of less than about 50 mg/100 g on a dry weight basis.

20. The method of claim 5, wherein the dry protein product comprises a source of prebiotic carbohydrates and comprises less than about 4% of readily available sugars comprising glucose, fructose, sucrose, or a combination thereof.
